(19) United States
(12) Patent Application Publication
(10) Pub. No.: US 2011/0242664 A1
(43) Pub. Date: Oct. 6, 2011

(54) SOLAR PANEL ENABLING THE DISPLAY OF AN IMAGE

(75) Inventors: Guillaume Counil, Aubervilliers (FR); Michele Schiavoni, Paris (FR); Patrick Gayout, Villemomble (FR)

(73) Assignee: SAINT-GOBAIN GLASS FRANCE, Courbevoie (FR)

(21) Appl. No.: 13/133,400

(22) PCT Filed: Dec. 10, 2009
(86) PCT No.: PCT/FR2009/052479

§ 371 Date: Jun. 8, 2011

(30) Foreign Application Priority Data
Dec. 11, 2008 (FR) 0858467

(51) Int. Cl. G02B 27/12; B41M 1/12

(52) U.S. Cl. 359/619; 101/129

(57) ABSTRACT

An optical assembly configured to display an image on a solar panel covered on at least a part of its surface with a lenticular array, between which an image in the form of substantially equidistant parallel bands with a specific pitch is arranged. The lenticular array has a plane internal surface and an external surface formed by external faces of a series of adjacent identical transparent cylindrical elements whose generatrices are parallel to the bands. The external side of the base of each cylindrical element has an asymmetric profile. The width of each cylindrical element is equal to the pitch of the bands. The bands are arranged so that, for a first angle range of given incidences at which the optical assembly is intended to be observed, radiation can reach a zone in which a band is arranged, and for a second angle range of lower given incidences, radiation can reach an active surface of the solar panel in a zone at least partially not masked by the bands.

The present invention relates to an optical assembly, and more precisely to an improved solar panel of the type adapted to allow the display of an image on at least a part of its surface.

It is known that the use of solar panels has both restrictions and certain drawbacks.

In terms of restrictions, in order to provide their full efficiency these panels need to be arranged at well-determined angles relative to the angle of incidence of the solar rays, that is to say the angle formed by the latter with a straight line normal to the plane of the panel.

In terms of drawbacks, solar panels are generally dark in color, or even black, so that as regards their aesthetic appearance it is extremely difficult to integrate them in a setting.

This is why Patent FR 2 896 596 has proposed a solar panel which, while fulfilling its essential prime function of collecting solar radiation and converting it into electrical energy, furthermore allows an observer, capable of viewing the panel at a series of specific angles, to see an image on it.

This invention is particularly advantageous because it makes it possible in particular to attract an individual's attention to a particular message, in particular an advertising message, but also conversely to mask the solar panel itself from an observer's eyes by giving the image which it displays the appearance of the background on which it is arranged, in particular for example the appearance of a roof.

Such an improved solar panel, or optical assembly, consists of a solar panel of a known type, arranged on which there is a transparent film on which an image has been printed from which a series of parallel linear bands of identical width and equidistantly spaced apart have been removed, and a lenticular surface consisting of a juxtaposition of identical linear lenses of plano-convex cross section, the width of which is equal to the sum of the width of a transparent band plus the width of an image band, and the plane face of which is turned toward the image, the longitudinal axis of the lenses being parallel to the image bands and to the transparent bands, said transparent bands and said image bands being positioned between the surface of the solar panel and the lenticular surface, in the focal plane of the lenses, in such a way that an observer will see only the image bands or only the surface of the solar panel, this alternative depending on the viewing angle at which the lenticular surface is observed.

It is an object of the present invention to improve the solar panels of this type by providing an optical assembly making it possible to improve the two essential functions of these panels, namely the “vision function” i.e. forming the image perceived by an observer, and the “energy function” i.e. producing the electrical energy delivered by the panel. The present invention aims to improve in particular the extent of the observation range of the image, in particular for grazing angles. It is also an object of the present invention to allow the designers of such solar panels to control the relative importance of these two functions, that is to say favor one of them relative to the other, and to do so as a function of their specific requirements for particular applications.

The present invention thus relates to an optical assembly intended for displaying an image on the surface of a solar panel, of the type comprising a solar panel covered on at least a part of its surface with a lenticular array, between which an image is arranged in the form of substantially equidistant parallel bands with a specific pitch, characterized in that:
the lenticular array has a plane internal surface and an external surface formed by the external face of a series of adjacent identical transparent cylindrical elements whose generatrices are parallel to said bands,
the external side of the base of each cylindrical element has an asymmetric profile,
the width of the base of each cylindrical element is equal to the pitch of the bands,
the bands are arranged so that, for a first angle range of given incidences at which the optical assembly is intended to be observed, radiation can reach a zone in which a band is arranged, and so that, for a second angle range of given incidences which is different from the first angle range, radiation can reach the active surface of the solar panel in a zone at least partially not masked by the bands.

Said external side will preferably be formed by two portions which may comprise at least one straight-line segment that meet at an apex. The two portions may be connected by an arc with concavity curved inward.

At least one of the two portions may furthermore be formed by an arc with concavity facing inward, which may be a parabola arc. In one advantageous variant of the invention, the two portions will consist of two parabola arcs which meet at their apex, the axis of these two parabola arcs being perpendicular to the plane face of the lenticular array.

The bands may be formed on the internal face of the lenticular array or on the surface of the solar panel by a reproduction method such as, in particular, a screen-printing method or a printing method. They may also be supported by a transparent film, which may be adhesively bonded onto at least one of the optical surfaces with which it is in contact.

Furthermore:
the asymmetry of each cylindrical element may lie between 0.05 and 0.45 or between 0.55 and 0.95, and may preferably lie between 0.1 and 0.3 or between 0.7 and 0.9,
the pitch of the bands may lie between 0.1 mm and 10 mm, and may preferably be of the order of 4 mm,
the thickness of the lenticular array may lie between 0.1 mm and 10 mm, and may preferably be of the order of 3 mm,
the ratio of the offset of the bands to their pitch may lie between 0.05 and 0.5, and may preferably be of the order of 0.15,
the height of the cylindrical elements may lie between 0.05 mm and 1.5 mm, and may preferably be of the order of 0.5 mm,
the ratio of the width of the bands to their pitch may lie between 0.1 and 0.6, and may preferably be of the order of 0.17.

The present invention also relates to a roof panel, characterized in that it uses an optical assembly according to one of the characteristics above and is arranged on a roof. The bands of this panel may reproduce the geometry and/or the color of the roof on which it is arranged.

This panel may make an angle of between 0° and 50°, and preferably of the order of 35°, with the horizontal.

Besides use in the field of roof panels, the optical assembly according to the invention may also be used to produce display panels, for example arranged vertically, and in particular advertising panels.

The present invention also relates to a method for adjusting the positioning of a printing element intended to print colored bands parallel to the texturing of a lenticular array involved in the construction of an optical assembly as defined above, on a transparent support, consisting in particular of said lenticular array, characterized in that said method comprises the steps consisting in:
producing a model of said bands on the printing element,
reproducing these bands by means of the printing element, on an intermediate transparent support so as to constitute a template,
superimposing the template and the lenticular array,
orienting the template relative to the lenticular array so as to avoid any moiré effect,
in this position, arranging the printing element relative to the template according to the relationship previously established,
printing the bands.

The printing element may consist of a screen-printing screen. Furthermore, the bands may be printed on the plane face of the lenticular array or on the surface of the solar panel, and an ink or a paint of the enamel type may be used in order to do this.

An embodiment of the present invention will be described below by way of nonlimiting example with reference to the appended drawings, in which:

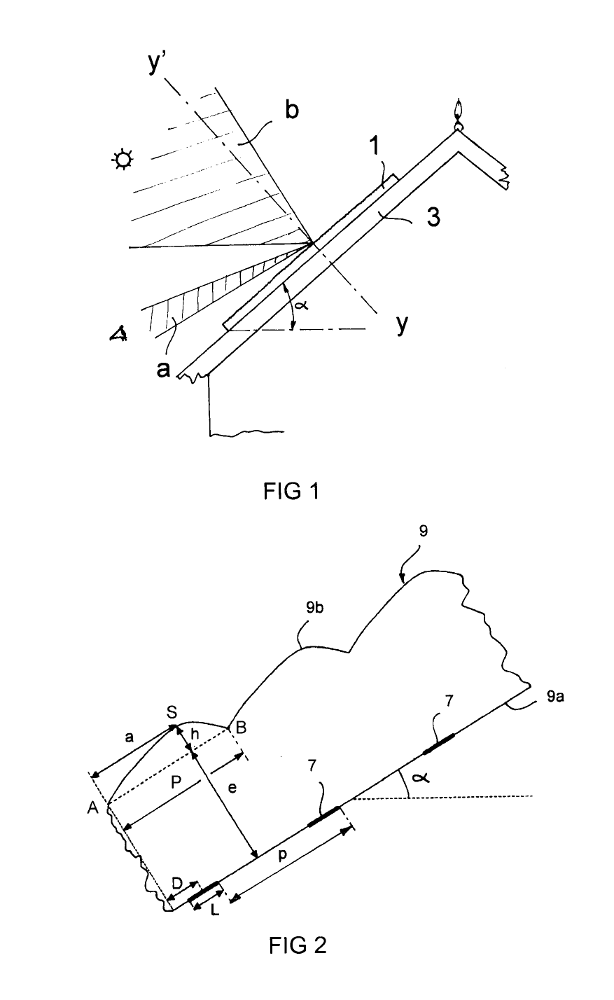

FIG. 1 is a partial overall view in elevation of an optical assembly according to the invention arranged on the roof of the building,

FIG. 2 is a schematic view in cross section of a lenticular array employed in the optical assembly according to the invention,

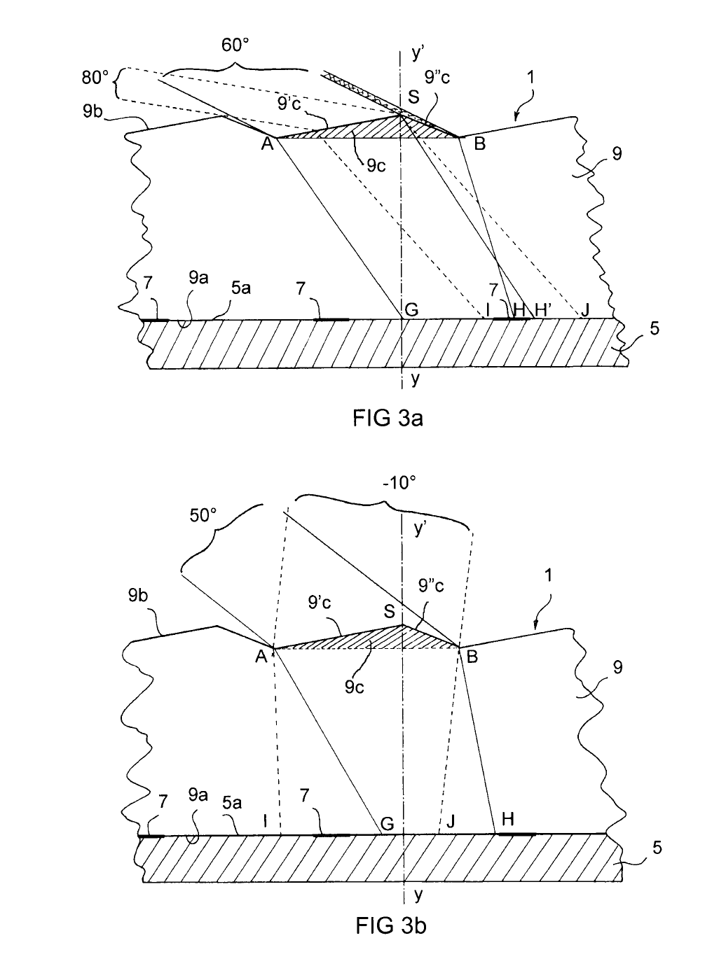

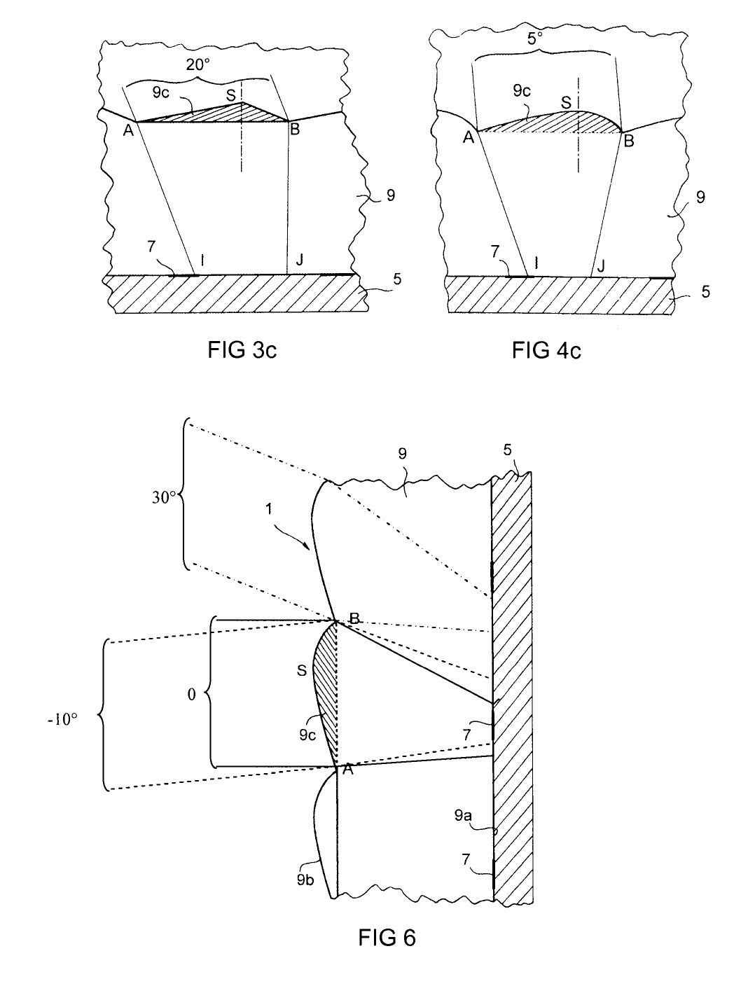

FIGS. 3a, 3b and 3c are partial views in cross section of an optical assembly according to the invention, in a configuration for respectively representing the “vision” function and the “energy” function,

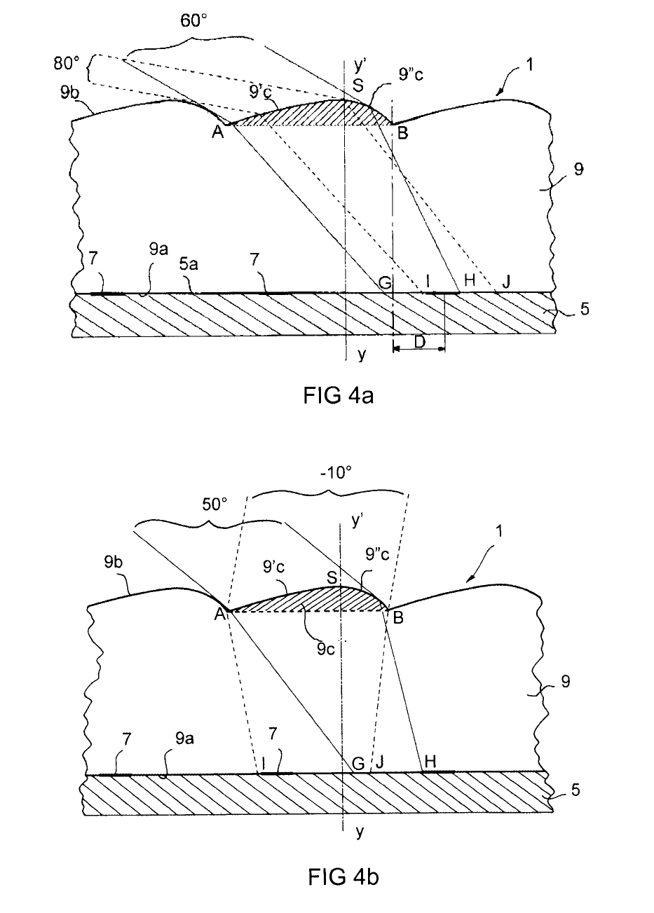

FIGS. 4a, 4b and 4c are partial views in cross section of an alternative embodiment of the optical assembly represented in FIGS. 3a to 3c,

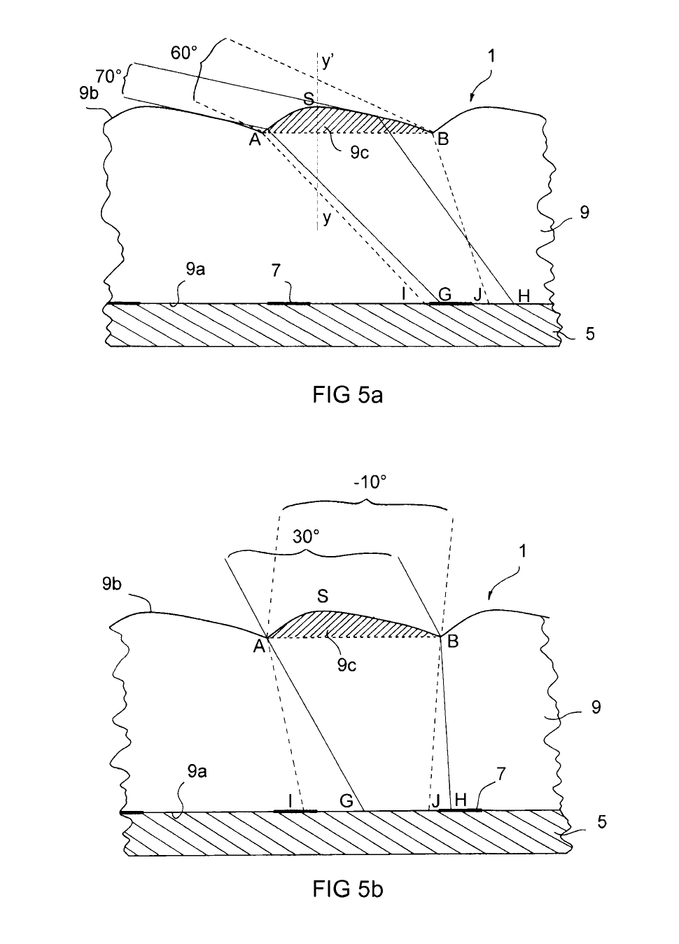

FIGS. 5a and 5b are partial views in cross section of another variant of an optical assembly according to the invention,

FIG. 6 is a partial view in cross section of another variant of an optical assembly according to the invention.

In the exemplary embodiment of the present invention as represented in FIG. 1, the optical assembly 1 is arranged on the tiles of the roof 3 of a dwelling, the roof being inclined by an angle α relative to the horizontal, and its appearance (“vision” function) is intended to be as discreet as possible for an individual observing it from the ground. In this embodiment, however, the energy function is intended to be favored over the vision function.

Under these conditions, the image with which the user is intended to be provided is a reproduction of the tiles in the middle of which the optical assembly 1 is arranged. Thus, as represented partially and schematically on a larger scale in FIGS. 3a to 3c, the optical assembly 1 consists of a solar panel 5 on the external face 5a of which a lenticular array 9 is arranged.

This lenticular array, which consists of a transparent material such as in particular glass, comprises a plane internal face 9a which is applied against the solar panel 5, and a textured external face 9b. FIG. 2 represents a schematic example of such a lenticular array in relation to the references used below for denoting its constituent elements. The lenticular array is combined with the solar panel by any technique known to the person skilled in the art, in particular by lamination with a thermoplastic interlayer (EVA, PVB, etc.).

The plane internal face 9a is covered with a series of parallel linear colored bands 7 reproducing the shape and color of the tiles of the roof 3. These bands 7 are produced in particular by a method of the screen-printing type, although any other reproduction method could also be used. The bands 7, with a width L of the order of 1 mm, are distributed over the face 9a with a pitch p of the order of 4 mm in the present example.

According to the invention, the bands 7 may also be formed on that face of the solar panel 5 which is intended to come in contact with the plane face 9a of the lenticular array 9.

The bands 7 may also consist of elements which are adhesively bonded onto at least one of the optical surfaces intended to be placed in contact, namely one face of the solar panel 5 and the plane face 9a of the lenticular array 9.

The textured external face 9b of the lenticular array 9 is formed by the external faces of cylindrical elements 9c, which have generatrices respectively parallel to the longitudinal direction of the bands 7 and the base surfaces of which substantially consist of triangles ASB of height h, the point S lying at the apex of the texture, and its projection onto the segment AB lying at a distance a from the end A. Each of these cylindrical elements 9c thus forms a diopter, the cross section of which is hatched in the figures. The width AB, or pitch P, of each of the diopters 9c is close to the value of the pitch p of the bands 7 and preferably equal to it. In the present embodiment, the side AS lying on the side intended for observation is of larger length so as to give the diopter 9c an asymmetric shape, this asymmetry being defined below by the ratio a/P=0.8, where the distance a is defined as the distance between the point A and the projection of the apex S onto the segment AB.

As regards the “vision” function, FIG. 3a represents the extreme rays capable of being refracted by each of the diopters, for two incidences, namely 60° (solid lines) and 80° (dashed lines) relative to the normal yy′ to the plane face 9a of the lenticular array, which are the extreme incidences at which an observer is intended to be capable of observing the optical assembly 1. The bundle of rays with 60° incidence is thus refracted into a base zone GH of the plane 5a bearing the bands 7, and the bundle of rays with 80° incidence is likewise refracted into a base zone IJ.

Provision will be made to arrange the bands 7 such that they are located and cover the common base zone IH so that under these conditions, irrespective of the angle between 60° and 80° at which an observer views the optical assembly according to the invention, he or she will see the band portion contained in the base zone IH. As represented in FIG. 3a, it is possible to improve the efficiency of the “vision” function by widening the band 7 in the zone HH′, the latter corresponding to the 60° incidence rays of the doubly hatched portion which is negligible in this example. The center of each of the bands 7 is thus offset by a distance D relative to the projection of the point A onto the plane where the bands lie.

As regards the energy function, FIG. 3b represents the extreme solar rays capable of being refracted through each of the diopters 9c, for two incidences, namely 50° (solid lines) and −10° (dashed lines) relative to the normal yy′ to the plane face 9a of the lenticular array; these incidences constitute the extreme values at which the solar radiation strikes the optical assembly when it is oriented toward the south with an inclination α=35° relative to the horizontal in a geographical zone of latitude 45° north.

It can be seen that in the arrangement represented in FIG. 3b, the bundle of solar rays with 50° incidence strikes the solar panel 5 in a base zone GH free of bands 7, so that the latter do not obscure the active surface of the solar panel 5 at all. As regards the bundle of solar rays with −10° incidence, this is not the case, and it can be seen that they strike the solar panel 5 in a base zone IJ in which a band 7 lies, so that the latter obscures a part of the active surface of the solar panel 5, making it lose some of its efficiency.

It can be seen, as represented in the partial arrangement in FIG. 3c, that in the present arrangement the obscuration of the surface of the solar panel 5 by a band 7 occurs progressively starting from a solar ray incidence of the order of 20°.

The results obtained with such an optical assembly according to the invention, in which the base of the cylindrical elements forming the diopters 9c is triangular, are shown below:

### EXAMPLE 1

Configuration:
optical assembly arranged on inclined roofing α=35°
orientation: south
geographical location: latitude 45° north
shape: straight sides
thickness e: 3 mm
pitch p: 4 mm
height h: 1 mm
band offset D: 0.8 mm (D/p=0.2)
band width L: 0.8 mm (L/p=0.2)
asymmetry a/P: 0.8 (a=3.2 mm)

Performance:
efficiency of the energy function: 86%
efficiency of the vision function:
   60° incidence: 26%
   70° incidence: 16%
   80° incidence: 19%

In an alternative embodiment of the present invention, the faces 9′c and 9″c of the diopter 9c have been made capable of focusing the light rays by giving each of them a curvature, particularly in the form of a parabola arc, as represented in FIGS. 4a and 4b. These two parabola arcs AS and SB meet at the point S which constitutes their apex, and the axis of these two parabola arcs is formed by the axis yy′ passing through the point S and perpendicular to the plane face 9a of the lenticular array 9. As before, these two arcs have unequal values, the arc AS lying on the side facing the observer being larger than the arc SB so that the diopter 9c is asymmetric, the ratio a/P being equal to 0.65.

As before, FIG. 4a represents the extreme rays capable of being refracted by each of the diopters 9c, for two series of incident rays, namely 60° (solid lines) and 80° (dashed lines) relative to the normal yy′.

As regards the vision function, it may be observed that the two extreme light rays respectively at 80° and 60° are refracted into the plane of the bands 7 in two base zones GH and IJ. It can be seen that these two zones overlap in the base zone IH. Under these conditions, it will be understood that if the bands 7 are given a width L equal to the latter and if the centers of the bands 7 are positioned at the distance D from the start of the diopter 9c, irrespective of the observer's viewing angle between 60° and 80°, he or she will see all of the bands, which represents an improvement over the previous embodiment.

FIG. 4b represents the preceding optical assembly 1 on which, as before, the extreme solar rays have been plotted for two series of incidences, namely 50° (solid lines) and −10° (dashed lines).

As regards the energy function, it can be seen that according to the present arrangement, the bundle of solar rays striking the diopter 9c at 50° incidence is refracted into the base zone GH, i.e. outside the zone occupied by the bands 7, so that the latter do not obscure the active surface of the solar panel. On the other hand, the bundle of solar rays with −10° incidence is refracted into the base zone IJ which includes a band 7, so that the latter obscures a portion of the active surface of the solar panel.

As represented in FIG. 4c, however, it can be seen that this obscuring occurs starting from 5° incidence, which represents an energy efficiency gain over the preceding embodiment.

The results obtained are shown in the table below:

### EXAMPLE 2

Configuration:
optical assembly arranged on inclined roofing α=35°
orientation: south
geographical location: latitude 45° north
shape: sides as parabola arcs
thickness e: 3 mm
pitch p: 4 mm
height h: 0.5 mm
band offset D: 0.6 mm (D/p=0.15)
band width L: 0.68 mm (L/p=0.17)
asymmetry a/P: 0.65 (a=2.6 mm)

Performance:
efficiency of the energy function: 93.5%
efficiency of the vision function:
   60° incidence: 41%
   70° incidence: 45%
   80° incidence: 41%

It can be seen that the present embodiment of the invention is particularly advantageous in so far as it makes it possible to improve both the energy function and the vision function. As regards the latter, the improvement also results from the homogeneity of the vision function efficiency, manifested by the fact that an observer of the optical assembly will not perceive any difference concerning the viewing quality of the bands when his or her viewing angle varies in the range of from 60° to 80°.

One difficulty in implementing the present invention is due to the need for rigorous positioning of the bands 7 relative to the texture 9c of the lenticular array, both laterally i.e. the offset of the bands relative to the diopter 9c (parameter D), and in a parallelism. The offset D is defined as the distance between the centers of the bands and the projection of the point A onto the plane in which the colored bands are formed.

The present invention provides a method for achieving this twofold positioning precisely, when the bands are formed on the lenticular array 9 in particular by reproduction means implying a printing element, for example of the screen-printing screen type.

According to this method, a screen-printing screen having bands 7 of width L, which are separated from one another by a pitch p, is produced in a first step; then a rigorous relationship between the screen-printing screen and a transparent intermediate support is obtained in a second step.

In a third step, the bands 7 are reproduced on this intermediate support by means of the screen-printing screen, so as to form a template.

Next, in a fourth step, the template is superimposed with the lenticular array intended to receive the bands. This assembly is then observed in transparency. When a “moiré” effect is observed, this means that the bands of the template are not parallel to the texturing of the lenticular array, and their relative orientation is then modified accordingly until a homogeneous appearance of the assembly is perceived. In this way, adjustment of the relative orientation of the template, and therefore the screen-printing screen which has a fixed relationship relative to it, is accomplished.

In order to achieve lateral positioning, that is to say positioning of the bands 7 relative to the diopter 9c, i.e. the offset D, the lenticular array 9 is displaced laterally relative to the template. When the overall appearance has the color of the bands 7, this means that the apices S of the diopters 9c are aligned with the centers of the bands and, conversely, when the overall appearance becomes transparent, this means that the centers of the bands 7 are aligned with the valleys of the texture. According to the desired offset D, this value can then be adjusted.

Finally, the relative position of the lenticular array with respect to the template is set. Under these conditions, all the lenticular arrays to be printed will have the same position with respect to the template, and therefore with respect to the screen-printing screen.

Once the correct positioning has been obtained, the screen-printing screen can be positioned with respect to the template according to the relative relationship of these two elements previously established; then, optionally after removing the template, the various printing operations can be performed.

The present invention is particularly advantageous in so far as it allows the designer, according to his or her own needs and restrictions, to favor either the vision function or the energy function, and to do so by adjusting the width L and the offset D of the bands 7.

In this way, in one embodiment of the invention, if the intention is to present a message to the eyes of passers-by, in particular an advertising message, it may be advantageous to give priority to the vision function at the cost of the energy function. The bands 7 may then be widened on either side of the base zone IH, as represented in FIG. 4a, which will have the effect of improving the vision function while of course consequently obscuring the active surface of the solar panel 5 more by the bands 7, thus reducing the efficiency of the solar panel.

In this way, in a third exemplary embodiment of the present invention, an optical assembly has been constructed in which the bands 7 have a width L of 2 mm, thus representing half the pitch p. It will be noted that in such a configuration, the active material, in particular silicon, may consist of bands, which makes it possible to reduce the surface area of it being used and thus to make substantial savings owing to the high cost of this active material.

The results obtained are shown in the table below:

### EXAMPLE 3

Configuration:
optical assembly arranged on inclined roofing α=35°
orientation: south
geographical location: latitude 45° north
shape: sides as parabola arcs
thickness e: 3 mm
pitch p: 4 mm
height h: 0.5 mm
band offset D: 0.68 mm (D/p=0.17)
band width L: 2 mm (L/p=0.5)
asymmetry a/P: 0.65 (a=2.6 mm)

Performance:
efficiency of the energy function: 75%
efficiency of the vision function:
   60° incidence: 80%
   70° incidence: 100%
   80° incidence: 100%

It can be seen that the vision function is at its maximum and the energy function, although reduced, nevertheless still has a value acceptable for many applications.

As represented in FIGS. 5a and 5b, the profile of the diopters 9c may also be reversed, that is to say its asymmetry i.e. the ratio a/P is less than 0.5, so that the arc AS lying on the observation side is smaller in size than the arc SB.

As before, FIG. 5a represents the extreme rays capable of being refracted by each of the diopters 9c, for two series of incident rays, namely 70° (solid lines) and 60° (dashed lines).

As regards the vision function, it may be observed that the two extreme light rays, respectively at 70° (solid lines) and 60° (dashed lines), are refracted into the plane of the bands 7 in two base zones GH and IJ. It can be seen that although the 60° incidence rays are indeed refracted into a zone which contains the bands, the same is not true of the rays with 70° incidence at which an observer cannot observe the entire width of the band 7. It will be understood that for this angle, the vision function will not be optimal.

As regards the energy function, FIG. 5b represents the bundle of solar rays with respective incidences 30° and −10°, and it can be seen that for the corresponding refracted rays, some of the active surface of the solar panel 5 is obscured by the bands 7. It can furthermore be seen that the bundle with an intermediate angle of incidence at 10°, as represented in FIG. 5c, is refracted into a zone GH which lies outside the surface of the bands 7 so that the efficiency is maximal for this incidence.

The results obtained are shown in the table below:

### EXAMPLE 4

Configuration:
optical assembly arranged on inclined roofing α=35°
orientation: south
geographical location: latitude 45° north
shape: sides as parabola arcs
thickness e: 3 mm
pitch p: 4 mm
height h: 0.62 mm
band offset D: 0.32 mm (D/p=0.08)
band width L: 1 mm (L/p=0.25)
asymmetry a/P: 0.25 (a=1 mm)

Performance:
efficiency of the energy function: 90%
efficiency of the vision function:
   60° incidence: 75%
   70° incidence: 38%
   80° incidence: 20%

It is of course possible to arrange an optical assembly according to the invention on a support other than a roof and in particular, as represented in FIG. 6, on a vertical wall of a building, particularly in order to use it both for communicating information to the public, for example an advertising message, and to produce energy.

The results obtained are shown in the table below:

### EXAMPLE 5

Configuration:
optical assembly arranged vertically
orientation: south
geographical location: latitude 45° north
shape: sides as parabola arcs
thickness e: 3 mm
pitch p: 4 mm
height h: 0.62 mm
band offset D: 0.16 mm (D/p=0.4)
band width L: 0.8 mm (L/p=0.2)
asymmetry a/P: 0.75 (a=1 mm)

Performance:
efficiency of the energy function: 90.5%
efficiency of the vision function:
   0° incidence: 29%
   −10° incidence: 25%

As regards the vision function, it can be seen that although the efficiency is not too high it is nevertheless homogeneous, which is very important for an observer; this efficiency may of course be improved by widening the bands 7, as explained above, according to the designer's wishes and the function which he or she wishes to favor.

1-27. (canceled)

28. An optical assembly configured to display an image on a surface of a solar panel covered on at least a part of its surface with a lenticular array, between which an image is arranged in a form of substantially equidistant parallel bands with a specific pitch, wherein:
the lenticular array includes a plane internal surface and an external surface formed by an external face of a series of adjacent identical transparent cylindrical elements whose generatrices are parallel to the bands;
an external side of the base of each cylindrical element has an asymmetric profile;
a width of the base of each cylindrical element is substantially equal to a pitch of the bands; and
the bands are arranged so that, for a first angle range of given incidences at which the optical assembly is intended to be observed, radiation can reach a zone in which a band is arranged, and for a second angle range of given incidences that is different from the first angle range, radiation can reach an active surface of the solar panel in a zone at least partially not masked by the bands.

29. The optical assembly as claimed in claim 28, wherein the external side is formed by two portions that meet at an apex.

30. The optical assembly as claimed in claim 29, wherein the two portions comprise at least one straight-line segment.

31. The optical assembly as claimed in one of claim 29, wherein the two portions are connected by an arc with concavity curved inward.

32. The optical assembly as claimed in one of claim 29, wherein at least one of the two portions is formed by an arc with concavity facing inward.

33. The optical assembly as claimed in claim 32, wherein the arc with concavity facing inward is a parabola arc.

34. The optical assembly as claimed in claim 33, wherein the two portions include two parabola arcs that meet at their apex, axis of the two parabola arcs being perpendicular to the plane face of the lenticular array.

35. The optical assembly as claimed in claim 28, wherein the bands are formed on the internal surface of the lenticular array.

36. The optical assembly as claimed in claim 28, wherein the bands are formed on the surface of the solar panel, or between active material bands of the solar panel.

37. The optical assembly as claimed in claim 28, wherein the bands are formed by a reproduction method or a screen-printing method.

38. The optical assembly as claimed in claim 28, wherein the bands are born by a transparent film.

39. The optical assembly as claimed in claim 38, wherein the transparent film is adhesively bonded to at least one of the optical surfaces with which it is in contact.

40. The optical assembly as claimed in claim 28, wherein the asymmetry of each cylindrical element lies between 0.05 and 0.45, or between 0.55 and 0.95, or between 0.1 and 0.3, or between 0.7 and 0.9.

41. The optical assembly as claimed in claim 28, wherein the pitch of the bands lies between 0.1 mm and 10 mm, or is of an order of 4 mm.

42. The optical assembly as claimed in claim 28, wherein the thickness of the lenticular array lies between 0.1 mm and 10 mm, or is of an order of 3 mm.

43. The optical assembly as claimed in claim 28, wherein the ratio of offset of the bands to their pitch lies between 0.05 and 0.5, or is of an order of 0.15.

44. The optical assembly as claimed in claim 28, wherein a height of the cylindrical elements lies between 0.05 mm and 1.5 mm, or is of an order of 0.5 mm.

45. The optical assembly as claimed in claim 28, wherein the ratio of a width of the bands to their pitch lies between 0.1 and 0.6, or is of an order of 0.17.

46. A roof panel configured to be arranged on a roof, comprising an optical assembly as claimed in claim 28.

47. The roof panel as claimed in claim 46, wherein the bands reproduce a geometry and/or color of the roof on which the panel is configured to be arranged.

48. The roof panel as claimed in claim 46, making an angle of between 0° and 50°, or of an order of 35°, with the horizontal.

49. A display panel configured to be arranged substantially vertically, comprising an optical assembly as claimed in claim 28.

50. A method for adjusting positioning of a printing element configured to print colored bands parallel to texturing of a lenticular array involved in construction of an optical assembly as claimed in claim 28, on a transparent support, including the lenticular array, the method comprising:
producing a model of the bands on the printing element;
reproducing the bands by the printing element, on an intermediate transparent support so as to constitute a template;
superimposing the template and the lenticular array;
orienting the template relative to the lenticular array so as to avoid any moiré effect;
in the oriented position, arranging the printing element relative to the template according to the relationship previously established; and
printing the bands.

51. The method as claimed in claim 50, wherein the printing element includes a screen-printing screen.

52. The method as claimed in claim 50, wherein the bands are printed on a plane face of the lenticular array.

53. The method as claimed in claim 50, wherein the bands are printed on the surface of the solar panel.

54. The method as claimed in claim 50, wherein the bands are printed by a paint or an ink of enamel type.
